(19) United States
(12) Patent Application Publication
(10) Pub. No.: US 2012/0323846 A1
(43) Pub. Date: Dec. 20, 2012

(54) Sending Category Information

(75) Inventors: Zhenguo Bai, Hangzhou (CN); Li Kun Guan, Hangzhou (CN); Luo Dong Shen, Hangzhou (CN)

(73) Assignee: ALIBABA GROUP HOLDING LIMITED, Grand Cayman (KY)

(21) Appl. No.: 13/522,124

(22) PCT Filed: May 11, 2012
(86) PCT No.: PCT/US12/37464

§ 371 Date: Jul. 13, 2012

(30) Foreign Application Priority Data
May 12, 2011 (CN) 201110122327.2

(51) Int. Cl. G06F 17/30

(52) U.S. Cl. 707/610; 707/E17.01

(57) ABSTRACT

The present disclosure introduces a method, a system and an apparatus of sending category information. Category information at central data storage media is stored at a category server in the form of one or more files. When the category server receives a category identification from a terminal to request corresponding category attribute information for publishing product information, the category server may inquire and return the requested category information without submitting an inquiry to the central storage media, thereby reducing operational pressure on the central data storage media and improving efficiency of publishing product information.

### CROSS REFERENCE TO RELATED PATENT APPLICATIONS

This application is a national stage application of an international patent application PCT/US12/37464, filed May 11, 2012, which claims foreign priority to Chinese Patent Application No. 201110122327.2 filed on 12 May 2011, entitled “Method, System, and Apparatus of Sending Category Information,” which applications are hereby incorporated by reference in their entirety.

TECHNICAL FIELD

The present disclosure relates to the field of computer technology and, more specifically, to a method, a system, and an apparatus of sending category information.

### BACKGROUND

Product information published on a product trading platform includes category information. The category information includes a category identification of a product category and category attribute information corresponding to the category identification. The category identification indicates an identification label of the product category of a product according to characteristics of the product. Each product has its corresponding category identification. The category attribute information corresponding to the category identification can be used to describe the product.

All category information is stored at one or more central data storage media of the product trading platform. The central data storage media can provide the category information to external users. In order to ensure that the category attribute information correctly indicates the attributes of the product, the category attribute information stored at the central data storage media are continuously adjusted, improved, and updated.

As the category attribute information is adjusted in real-time, if the adjusted category attribute information is synchronized to the central data storage media whenever the category attribute information changes, the synchronization process will occupy a lot of resources of the central data storage media when the category attribute information changes frequently. Thus, the trading of other products may not be normally operational, especially when the product trading platform is busy. Therefore, when the category attributes information changes, it is not immediately synchronized to the central storage media. Instead, changing event information (including a changing time, a changing content, etc.) of the category attribute information is stored in another databases (such as an operation category attribute database). When the product trading platform is idle, the changing event information of the category attribute information recorded in the operation category attribute database is synchronized to the central data storage media so that the category attribute information maintained at the central data storage media is updated periodically.

FIG. 1 illustrates a conventional process that the category attribute information stored in the central data storage media is provided to the external users to publish product information.

At 102, a publication plug-in that is installed at a terminal 104 submits a request to a category server 106 to obtain one or more product categories of a product.

At 108, the category server 106 inquires about category information stored in one or more central data storage media 110 according to a relationship between product identifications and category identifications, determines one or more category identifications of the one or more product categories requested by the terminal 104.

At 112, the category server 106 returns the determined category identifications to the terminal 104.

As a product may belong to different categories, a product may have different corresponding category identifications. For example, a product named “apple” may belong to a “fruit” category or a “mobile phone” category. For another example, a product named “a mobile phone with thermometer functions” may belong to a “mobile phone” category or a “thermometer” category.

As there may be different category identifications determined by the category server 106 by inquiring the category information in the central data storage media 110, following inquiry operations for category attribute information may be conducted when the terminal 104 selects at least one category identification from the received category identifications.

At 114, the publication plug-in installed at the terminal 104 submits a request to the category server 106 to obtain category attribute information corresponding to the product category.

The terminal 104 requests the category server 106 for the category attribute information by sending selected one or more category identifications to the category server 106. The one or more category identifications sent by the terminal 104 to the category server 106 may be at least one category identifications selected by the terminal 104 from the category identifications returned by the category server 106.

At 116, the category server 106 inquires about the category information stored in the central data storage media 110 according to a relationship between the category identifications and the category attribute information, and determines category attribute information corresponding to the category identifications sent by the terminal 104.

At 118, the category server 106 returns the determined category attribute information to the terminal 104.

At 120, the publication plug-in installed at the terminal 104 stores and publishes the received category identification of the product and the corresponding category attribute information.

FIG. 2 illustrates a structure diagram between one or more central data storage media 202, one or more category servers 204 (1) . . . 204 (n), and one or more terminals 206 (1), 206(2) . . . 206(n) in an example process of publishing product information, where m and n may be any integer. Each terminal may be installed with a publication plug-in.

During the process of publishing product information, when the terminal needs to publish product information for each product, the category server needs to conduct inquiry operations twice with the central data storage media. The central data storage media need to respond to a large amount of inquiry operations in a short time when a large number of terminals publish product information for different products. Thus, the responses of the central data storage media to the inquiry operations may be blocked and it may be difficult to send the category identification and the category attribute information from the central data storage media to the terminals. The response capability of the central data storage media becomes a bottleneck of the process of publishing product information.

### SUMMARY

The present disclosure discloses a method, a system, and an apparatus of sending category information.

The present disclosure discloses a method of sending category information. A file controller converts category identification and category attribute information stored at one or more central data storage media into a form of one or more files. The file controller synchronizes the category identification and the category attribute information in the form of files with a category server. The file controller also instructs the category server to determine a category of a product corresponding to a product identification sent by a terminal, and returns a category identification of the determined category and the category attribute information in the form of files corresponding to the category identification to the terminal.

The present disclosure also discloses another method of sending category information. A category server synchronizes category identification and category attribute information in the form of files. The category server determines a category of a product corresponding to a product identification. The product identification is sent by a terminal. The category server returns the category identification of the determined category and the category attribute information in the form of files corresponding to the category identification to the terminal.

The present disclosure discloses a system of sending category information. The system includes one or more central data storage media, a file controller, and a category server. The central data storage media stores category identification and category attribute information. The file controller converts category identification and category attribute information stored at the central data storage media into a form of one or more files. The file controller synchronizes the category identification and the category attribute information in the form of files with the category server. The category server determines a category of a product corresponding to a product identification after receiving the product identification sent by a terminal, and returns the category identification of the determined category and the category attribute information, in the form of files, corresponding to the category identification to the terminal.

The present disclosure discloses a file controller. The file controller includes a format conversion module and a sending module. The format conversion module converts category identifications and category attribute information stored at one or more central data storage media into a form of one or more files. The sending module synchronizes the category identifications and category attribute information in the form of files with a category server, instructs the category server to determine a category of a product corresponding to a product identification sent by a terminal, and returns a category identification of the determined category and the category attribute information in the form of files corresponding to the category identification to the terminal.

The present disclosure discloses a category server. The category server includes a synchronization module, a receiving module, and a sending module. The synchronization module synchronizes category identification and category attribute information in a form of one or more files. The receiving module receives a product identification sent by a terminal. The sending module determines a category of a product corresponding to the product identification sent by the terminal; and returns the category identification of the determined category and the category attribute information in the form of files corresponding to the category identification to the terminal.

The present disclosure provides techniques of sending category information. The category information in one or more central data storage media are stored at a category server in a form of one or more files so that the category server may locally inquire and return the category information requested by the terminal when it receives the request for the category identification and the category attribute information from the terminal. The category server does not have to inquire the central data storage media, thereby reducing operation pressure of the central date memory and improving the efficiency of the product information publication.

### BRIEF DESCRIPTION OF THE DRAWINGS

To better illustrate embodiments of the present disclosure, the following is a brief introduction of figures to be used in descriptions of the embodiments. It is apparent that the following figures only relate to some embodiments of the present disclosure. A person of ordinary skill in the art can obtain other figures according to the figures in the present disclosure without creative efforts.

FIG. 1 illustrates a process that category attribute information stored in one or more central data storage media are provided to external users to publish product information.

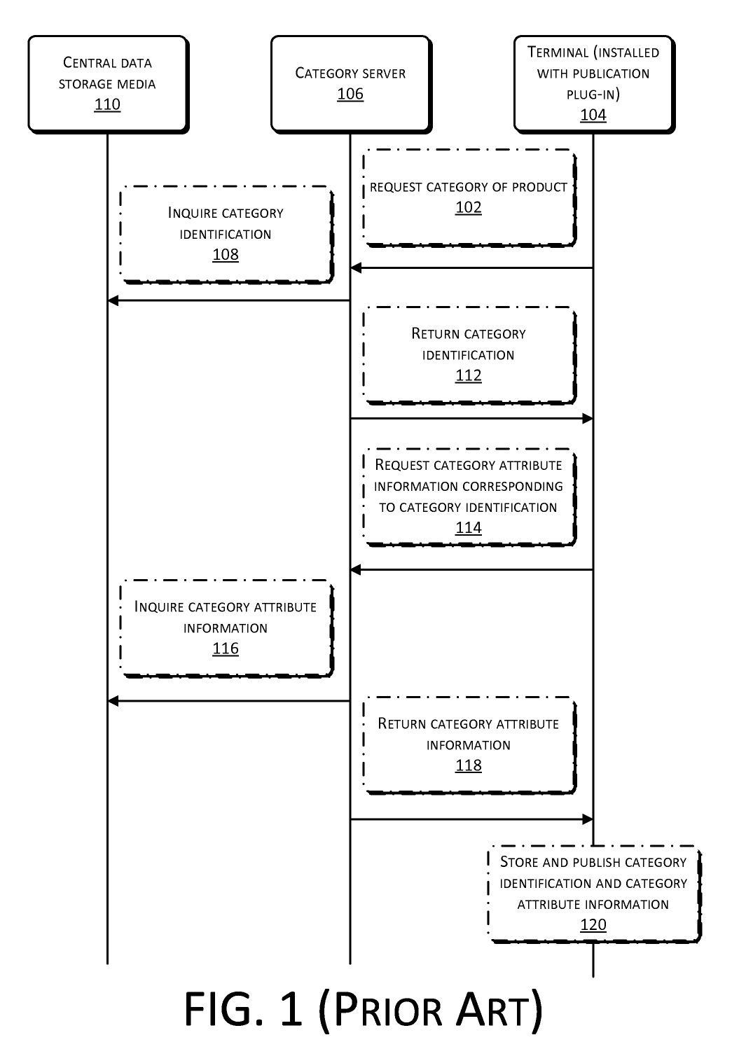

FIG. 2 illustrates a structure diagram between one or more central data storage media, one or more category servers, and one or more terminals in an example process of publishing product information.

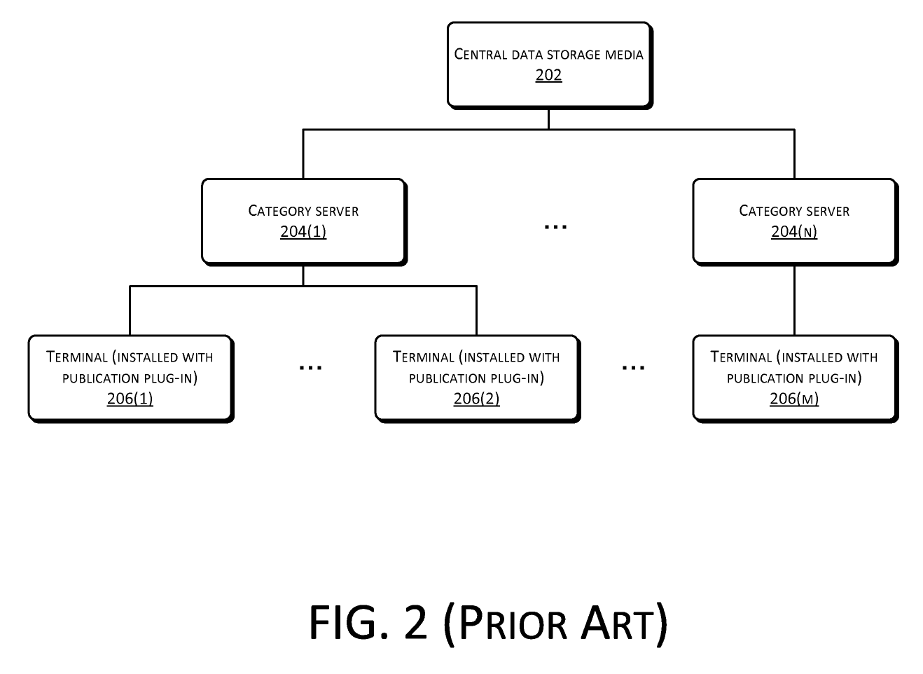

FIG. 3 illustrates a flowchart of an example process of sending category information in accordance with a first example embodiment of the present disclosure.

FIG. 4 illustrates a flowchart of an example process of sending category information in accordance with a second example embodiment of the present disclosure.

FIG. 5 illustrates a diagram of an example system of sending category information in accordance with a third example embodiment of the present disclosure.

FIG. 6 illustrates a diagram of an example file controller in accordance with a fourth example embodiment of the present disclosure.

FIG. 7 illustrates a diagram of an example category server in accordance with a fifth example embodiment of the present disclosure.

### DETAILED DESCRIPTION

The present disclosure provides techniques of sending category information in order to prevent central data storage media from becoming a bottleneck when responding to a large amount of inquiry operations and to reduce the operational pressure of the central data storage media and thereby enhance the efficiency of product information publication. The category information in the central data storage media is stored at one or more category servers in the form of one or more files. In this manner, the category servers may locally inquire and return the category information requested by one or more terminal upon receiving requests for one or more category identifications and category attribute information. It is not necessary for the category servers to inquire of the central data storage media, thereby reducing operational pressure of the central date storage media. A product trading platform may employ multiple category servers and each category server may provide this inquiry service for the terminals. The efficiency of publishing product information on request is thereby improved.

The following are detailed descriptions of present techniques for handling category information, with additional reference to the figures.

The central data storage media in an example embodiment of the present disclosure may be one or more storage devices (e.g., one or more storage databases) at the product trading platform to provide category information to external users. Operational staff may update, from time to time, the category information stored at the central data storage media.

The terminal in the example embodiment of the present disclosure may refer to a terminal device that is installed with a publication plug-in. The terminal may download category information (including initially downloaded category information and updated category information) by using the publication plug-in through a network, and display product information including the category information to users.

The category server in the example embodiment of the present disclosure may reside between the central data storage media and the terminal. It receives a download request from the terminal, and provides the category information to the terminal when it receives the category information from the central data storage media. The category server may reside at a Content Delivery Network (CDN) or at the product trading platform. If the category server resides at the CDN, it may employ CDN acceleration techniques to increase a speed of downloading category attribute information from the category server by the terminal and improve an efficiency of downloading information.

The file controller in the example embodiment of the present disclosure may be a component integrated with the central data storage media, a component integrated with the category server, or an independent device separate from the central data storage media and the category server. The file controller may read the category information from the central data storage media, process the category information, and synchronize the processed category information with the category server. A first example embodiment is described in detail below.

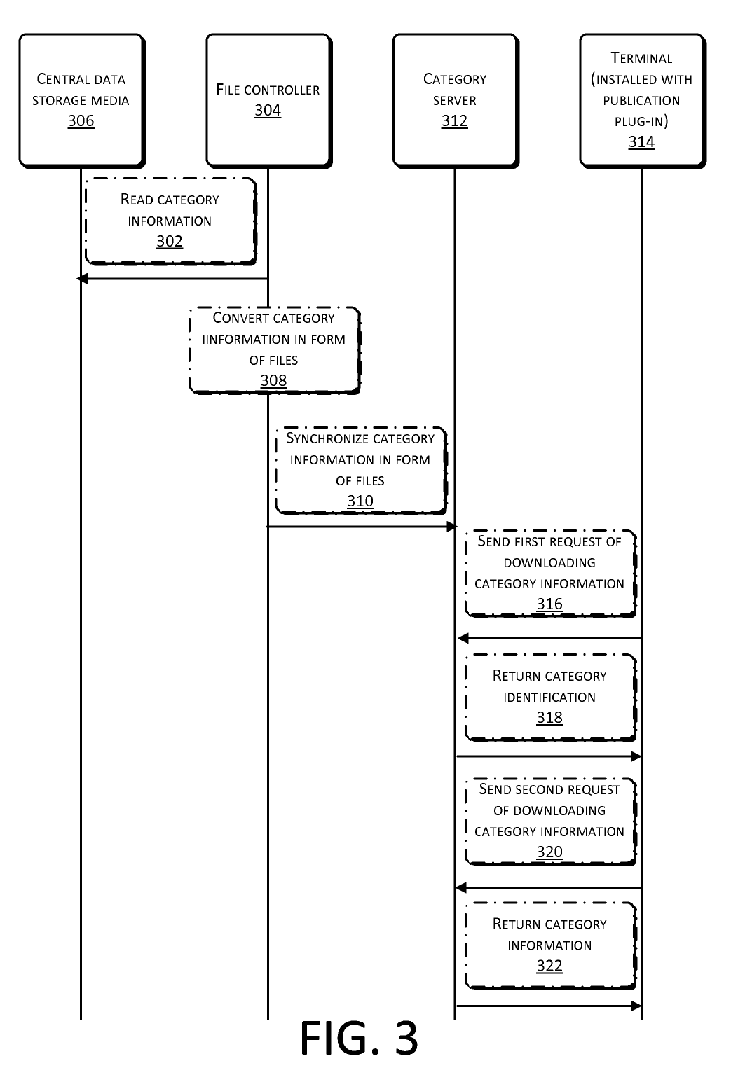

FIG. 3 illustrates a flowchart of an example process of sending category information in accordance with the first example embodiment of the present disclosure.

At 302, a file controller 304 reads category information stored in one or more central data storage media 306. The category information includes one or more category identifications and category attribute information.

There may be a large amount of category information and especially category attribute information stored in the central data storage media 306. It would cause operational pressure on the central data storage media 306 to update the category information stored in the central data storage media 306 in real-time. In this example embodiment, if the category information stored in the central data storage media 306 needs to be updated, such category information is not updated in the central data storage media 306 immediately. Instead, such category information is updated in the central data storage media 306 at a specific time or time period. In other words, in the first example embodiment, the category information stored in the central data storage media is stable before the specific time or time period to update the category information.

At 308, the file controller 304 converts the category identifications and category attribute information stored in the central data storage media 306 into a form of one or more files.

For example, the central data storage media 306 stores a table containing multiple, such as 10,000, category identifications, and their corresponding category attribute information. The operations at 308 may include following example steps.

At a first step, the file controller 304 converts the table containing the 10,000 category identifications into a category identification file and stores it to a designated directory (e.g., a temporary directory).

At a second step, the file controller 304 analyzes the 10,000 category identifications in the category identification file, and retrieves respective category attribute information corresponding to each category identification from the central data storage media 306. For example, in the central data storage media 306, the category attribute information may be stored based on a leaf-tree data structure. The file controller 304 may use each category identification as a leaf node to read its corresponding category attribute information from the central data storage media 306.

At a third step, the file controller 304 generates 10,000 category attribute information files separately. Each category attribute information file contains respective category attribute information corresponding to respective category identification. The file controller 304 has generated 10,001 files in total.

At 310, the file controller 304 synchronizes category information in the form of files with a category server 312.

In one example embodiment, a product trading platform may deploy multiple category servers. The file controller 304 may send the files of category information to some or all of the category servers.

With respect to one category server, such as the category server 312, the file controller 304 may use the following steps to synchronize the files of category information with the category server 312.

At a first step, the file controller 304 determines whether the category server 312 stores the category identification file. If the category server 312 does not store the category identification file, the file controller 304 synchronizes the category identification file obtained at 308 with the category server 312. If the category server 312 already stores the category identification file, the file controller 304 further determines whether the category identification file stored in the category server 312 is the same as the category identification files obtained at 308. If they are different, the file controller 304 synchronizes the category identification file obtained at 308 with the category server 312. If they are identical, it is not necessary to synchronize the category identification file with the category server 312.

At a second step, with respect to each category attribute information file, the file controller 304 determines whether an identical category attribute information file is stored in the category server 312. If the identical category attribute information file is stored in the category server 312, to save resources for data transmission, it is not necessary to synchronize the identical category attribute information file. The file controller 304 may synchronize the category attribute information file that is not already stored in the category server 312 with the category server 312.

Operations at 302, 308, and 310 may be regarded as independent transmission for the category information. The file controller 304 may read the category information in the central data storage media 306 in real-time to meet the requirement of a terminal 314 to download category information. Alternatively, the file controller 304 may read the category information in the central data storage media 306 after the category information in the central data storage media 306 have been updated to meet the requirement of the terminal 314 to update published category information.

After completing operations at 302, 308, and 310, the category server 312 stores the category information. When receiving new category information sent by the file controller 304, the category server 312 updates the stored category information. The category server 312 may provide the category information of products published by users to the terminal 314.

It should be noted that while operations at 302, 308, and 310 are illustrated by using the file controller 304 as a main operation entity, the example embodiment of the present disclosure may also use, but not limited to, one or more components in the category server 312 to read contents from the central data storage media 306 and to convert the category identifications and category attribute information into the form of files to conduct operations at 302, 308, and 310.

At 316, the terminal 314 sends a first request of downloading category information to the category server 312. The first request of downloading category information may include a product identification of a product to be published. A publication plug-in may be installed at the terminal 314 to facilitate this request and eventual publication.

At 318, the category server 312 determines one or more categories of the product corresponding to the received product identification and returns the one or more category identifications of the one or more categories to the terminal 314.

At 320, the terminal 314 sends a second request of downloading category information to the category server 312. The second request of downloading category information may include at least one of the one or more category identifications.

At 318, the category server 312 may determine that the product may belong to a number of categories. That is, the product may fall under multiple categories. Thus, the category server 312 may return respective category identification of each of the multiple categories of the product to the terminal 314. The terminal 314 may select one or more category identifications from the multiple category identifications, include them into the second request of downloading category information, and send the second request of downloading category information to the category server 312.

At 322, the category server 312 determines one or more category attribute information files corresponding to the received one or more category identifications according to the stored category attribute information files, and returns the category attribute information in the one or more category attribute files to the terminal 314.

For example, the publication plug-in at the terminal 314 may download the category attribute information from the category server 312 through a Hypertext Transfer Protocol (HTTP).

In the first example embodiment of the present disclosure, it is not necessary for the category server 312 to inquire information stored in the central data storage media 306 when it receives the request of downloading category information from the terminal 314 that installs the publication plug-in. Instead, the category server 312 responds the request of downloading category information from the terminal 314 through locally stored information, thereby effectively reducing operation pressure of the central data storage media 306 and improving the efficiency of publishing product information.

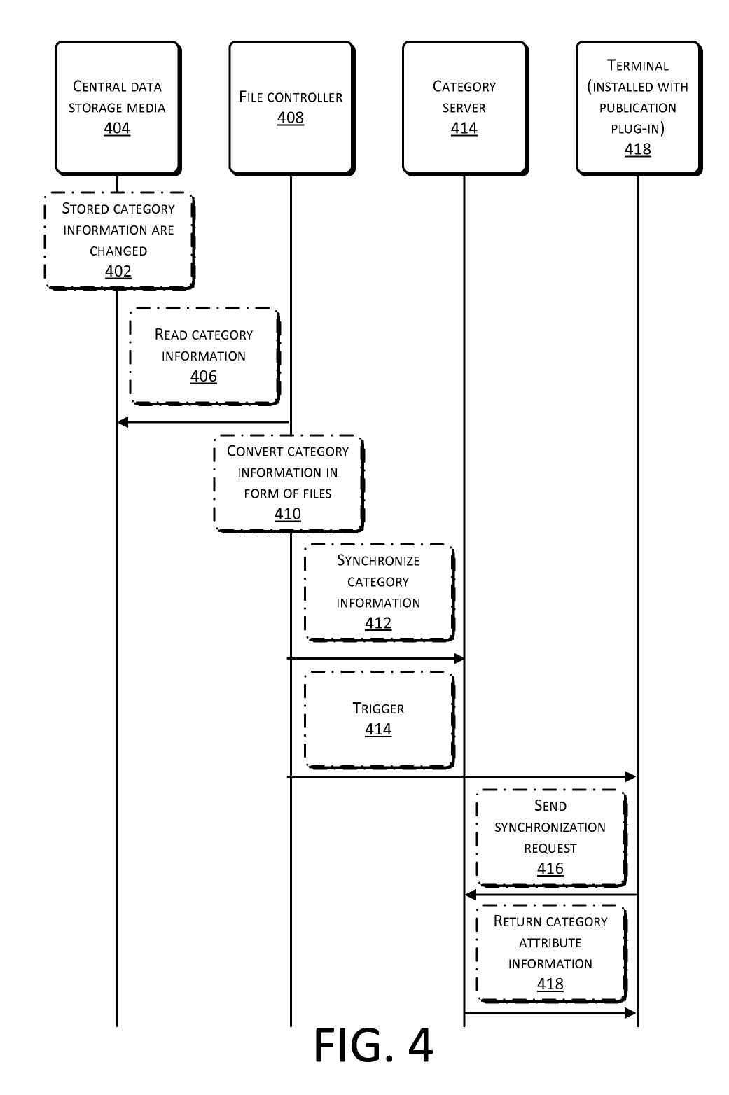

A second example embodiment is described in detail below. After an administrator conducts operations such as adding, deleting, or modifying on the category information in the central data storage media, the category information stored in the central data storage media is changed. The second example embodiment provides techniques for timely updating the changed category information to the category server and the terminal based on the basis of the first example embodiment. FIG. 4 illustrates a flowchart of an example process of sending category information in accordance with the second example embodiment of the present disclosure.

At 402, the category attribute information stored in central date storage media 404 is changed. At 406, a file controller 408 reads the changed category information in the central storage media 404. At 410, the file controller 408 converts updated category attribute information in the central data storage media 404 into a form of one or more files.

Operation at 402, 406, and 410 may be a special case of operation at 302 under the first example embodiment. At 302, based on a condition that the category attribute information stored in the central date storage media 306 changes, the file controller 304 may convert the updated category attribute information in the central data storage media 306 into files. Then, the techniques under the first example embodiments are implemented. Alternatively, operations at 322 under the first example embodiment may be subsequently performed.

At 410, the file controller 408 may convert all category attribute information in the central data storage media 404 into files. Suppose, for example, that the central data storage media 404 stores 10,000 category identifications. The file controller 408 uses each category identification as a leaf node to reads the corresponding category attribute information from the central data storage media 404, and generates 10,000 category attribute information files. Alternatively, the file controller 408 may convert category attribute information that have been changed to the form of files. For example, category attribute information corresponding to 100 category information identifications that have been changed in the central data storage media 404. The file controller 408 then generates 100 new category attribute information files.

At 412, the file controller 408 synchronizes the updated category attribute information in the form of files with a category server 414.

Operations at 412 are similar to those at 310 under the first example embodiment of the present disclosure.

At 414, the file controller 408 triggers a terminal 418 to send a request for synchronization. The terminal 418 may be installed with a publication plug-in.

The sequence of performing operations at 412 and 414 are not fixed. Operations at 412 and 414 may also be performed concurrently. After the file controller 408 synchronizes the changed category attribute information at the central data storage media 404 with the category server 414, the file controller 408 also notifies the terminal 418 of an event that the category attribute information is changed. The notification procedure may be conducted as follows.

For example, as there is a periodical heartbeat connection between a publication server at the remote network and the publication plug-in installed at the terminal, the publication server can detect the publication plug-in installed at the terminal that is in operation. When the file controller determines that the category attribute information are changed, it notifies the publication server of the event that the category attribute information are changed. The publication server notifies all terminals installed with the publication plug-ins in operations, and instructs the terminals to request, through the publication plug-ins in operation, the category attribute information which have been synchronized and updated from the category server.

As there are a large number of terminals that have installed the publication plug-in, there will be excessive information stored at the publication server if the publication server records category information identifications stored at each terminal with publication plug-in. Thus, in one example embodiment, when the publication server detects the changes of the category attribute information, it does not differentiate the terminals that have installed the plug-ins. In other words, the publication server does not identify specific category identifications already stored at each terminal. Instead, the publication server notifies all terminals to send the synchronization requests to the category server, and the category server determines whether it is necessary to return the updated category attribute information to the terminals.

While operations at 406, 412, and 414 are illustrated by using the file controller 408 as the main operation entity, the operations at 406, 412, and 414 may also be, but limited to, performed by one or more components having similar function at the category server 414.

At 416, the terminal 418 send a synchronization request to the category server 414.

The synchronization request includes one or more category identifications, which indicates that the terminal 418 requests to synchronize the category attribute information that correspond to the one or more category identifications.

For example, in order to reduce the amount of information transmission when synchronizing the category attribute information and to further reduce the transmission loading of the category server, a field “last_modified” may be used to carry a last modification time of the information. The “last_modified” field is appended in the HTTP head to record the last modification time of the information (i.e., the time when the information is generated) while static resources are downloaded through the HTTP. When the terminal downloads the category attribute information from the category server, the terminal also locally stores the time when the category attribute information is generated, which is included in the field “last_modified.” Next time, when the terminal sends the synchronization request to the category server, the time information may also be recorded in the field “last_modified” in the HTTP head to indicate the generation time of the category attribute information corresponding to the category identification already stored in the terminal (i.e., the generation time of the category attribute information that is already downloaded from the category server and is stored in the terminal).

At 418, the category server 414 determines whether to send the updated category attribute information in the form of files to the terminal 418 according to the category identifications carried in the synchronization request.

If the synchronization request contains the time information, the category server 414 further compares the received time information and the locally stored time at the category server 414 when the category attribute information corresponding to the category identification is generated. In other words, for the category attribute information corresponding to the same category identification, the category server 414 compares the time information from the terminal 418 and the locally stored time at the category server 414 when the updated category attribute information is generated.

If the category server 414 determines that the time information sent by the terminal 418 is earlier than the locally stored time at the category server 414 when the category attribute information corresponding to the category identification is generated, it means that the category attribute information corresponding to the category identification has changed after the category attribute information is sent to the terminal 418 and the category attribute information stored in the terminal 418 is out of date. Thus, the category server 414 sends the updated category attribute information, corresponding to the category identification, in the form of files to the terminal 418.

If the category server 414 determines that the time information sent by the terminal 418 is the same as the locally stored time at the category server 414 when the category attribute information corresponding to the category identification is generated, it means that the category attribute information corresponding to the category identification has not changed after the category attribute information is sent to the terminal 418 and the category attribute information stored in the terminal 418 is up to date. Thus, the category server 414 may return a message to the terminal 418 to indicate that it is not necessary to download the category attribute information into the terminal 418.

The category server 414 may use, but not limited to, the category identification and time information included in the synchronization request to determine whether to send the updated category attribute information in the form of file to the terminal 418. Some other methods may be performed to determine whether to send the updated category attribute information in the form of file to the respective terminal.

For example, after receiving the synchronization request from a respective terminal, the category server determines the category identifications corresponding to the terminal identification of the respective terminal that sends the synchronization request according to a relationship between stored terminal identifications and category identifications. In other words, the category server determines the category identifications that have been sent to the respective terminal. As the updated category attribute information synchronized in the category server may not be the category attribute information that the terminal needs, the category server, after determining the category attribute information already stored in the respective terminal, determines whether the category attribute information that the terminal needs have any updates. If there are any updates, the updated category attribute information in the form of files are sent to the respective terminal. Otherwise the category server does not send the updated category attribute information to the respective terminal.

At either 322 in the first example embodiment or 418 in the second example embodiment, the respective terminal may download the category attribute information from the category server. Compared with the current techniques that download the category attribute information from the central data storage media, the techniques used by the category server are more flexible and convenient than those used by database. The respective terminal may download the category attribute information in the form of files from the category server through breakpoint continuous transmission. For example, the respective terminal and the category server may negotiate a maximum download data amount through an array field, such as a maximum download amount 8 K bytes every time. Though the respective terminal may face some difficulties in the download process when the network quality is poor, it may continue to download from the breakpoint of the previous download process when the network becomes better.

Under the current techniques, when the category attribute information stored in the central data storage media is changed, the central data storage media cannot timely notify the publication plug-ins and the publication plug-ins installed at the terminal may not timely invoke the update operation, and consequently the update of the product information published at the terminal may be delayed. The techniques in the second example embodiment may resolve such problem in the current techniques that delay updating. The file controller converts the updated category attribute information in the central data storage media in the form of files and synchronizes them with the category server, and notifies the terminals of the updated category attribute information and instructs the terminals to request the category server for downloading the updated category attribute information, thereby improving the updating efficiency of the product information published at the terminals.

Further, under the current techniques, when the publication plug-ins installed at the terminals request the category server for the updates of the category attribute information, the category server may only inquire and return corresponding category attribute information from the central data storage media according to the category identifications included in the requests of the terminal. For the category attribute information that have not been changed, the category server also has to send them to the terminal, thereby wasting transmission resource between the category server and the terminals and increasing the transmission loading of the category server. In the second example embodiment, the time information is carried in the synchronization request sent by the terminal so that the category server determines whether to synchronize the category attribute information in the terminal according to the time information. While the category attribute information in the terminals remains up to date, the transmission between the category server and the terminal may be reduced. The unnecessary transmission of the category attribute information is prevented, the transmission pressure of the category server is eased, and the downloading and updating efficiencies of the terminals are improved.

In addition, the techniques in the present disclosure may also use the characteristics of array supported by the http protocol to support the terminal to use breakpoint continuous transmission for downloading from the category server, thereby enhancing the stability of downloading the category attribute information from the terminal.

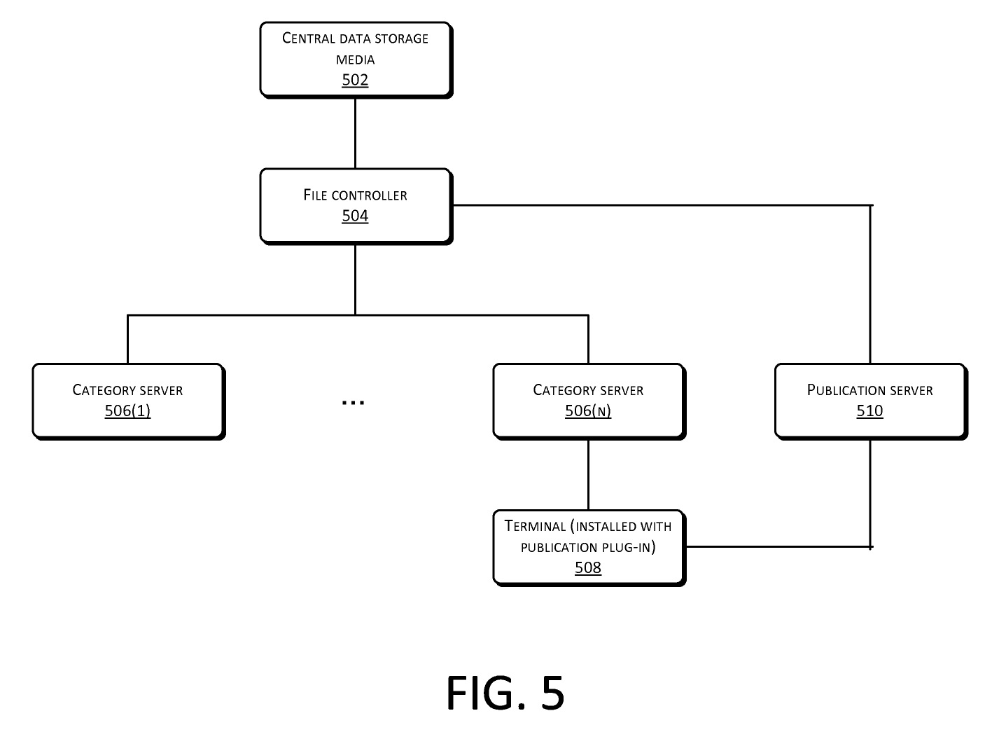

A third example embodiment is described in detail below. FIG. 5 illustrates a diagram of an example system of sending category information in accordance with the third example embodiment of the present disclosure.

The system includes one or more central data storage media 502, a file controller 504, and one or more category servers 506(1) . . . 506(n), where n can be any integer. The central data storage media 502 stores category identifications and category attribute information. The file controller 504 converts the category identifications and the category attribute information stored in the central data storage media into a form of one or more files and synchronizes them with the category servers 506. The category server, such as the category server 506(n), determines a category of a product corresponding to a product identification after receiving the product identification sent by a terminal 508, and returns a category identification of the determined category and category attribute information, in the form of files, corresponding to the category identification to the terminal 508. The terminal 508 may be installed with a publication plug-in.

The file controller 504 may generate a category identification file according to the category identifications stored in the central data storage media 502. The category identification file may include one or more category identifications. The file controller 504 may also generate one or more category attribute information files according to the category attribute information stored in the central data storage media 502. Each category attribute information file includes respective category attribute information corresponding to a category identification.

When the category attribute information stored in the central date media 502 are updated, the file controller 504 also converts the updated category attribute information in the central data storage media 502 into the form of one or more files, and synchronizes the updated category attribute information in the form of one or more files with the category servers 506. Then the file controller 504 triggers the terminal 508 to send a synchronization request. The category servers 506, when receiving the synchronization request, determine whether to send the updated category attribute information in the form of files to the terminal 508.

The system may also include a publication server 510. For example, as there is a periodical heartbeat connection between the publication server 510 at the remote network and the publication plug-in installed at the terminal 508, the publication server 510 may detect the publication plug-in installed at the terminal 508 that is in operation. When the file controller 504 determines that the category attribute information changes, it notifies the publication server 510 of the event that the category attribute information changes. The publication server 510 notifies all terminals, such as the terminal 508, installed with the publication plug-ins in operations, and instructs the terminals to request, through the publication plug-ins in operation, the category attribute information that have been synchronized and updated from the one or more category servers such as the category server 506(n).

A category server, such as the category server 506(n), after receiving the synchronization request sent from the terminal 508, determines the category identifications that have been sent to the terminal 508 and determines whether the category attribute information corresponding to the determined category identifications have been updated. If the category attribute information corresponding to the determined category identifications have been updated, the category server 506(n) sends the updated category attribute information, corresponding to the determined category identification, in the form of one or more files to the terminal 508. Otherwise, the category server 506(n) does not send the updated category attribute information to the terminal 508.

For another example, when the synchronization request includes the category identification and time information, the category server 506(n) compares the received time information and the locally stored time when the category attribute information corresponding to the category identification is generated. If the category server 506(n) determines that the time information sent by the terminal is earlier than the locally stored time when the category attribute information corresponding to the category identification is generated, the category server 506(n) sends the updated category attribute information, corresponding to the category identification, in the form of file to the terminal 508. Otherwise, the category server 506(n) does not send the updated category attribute information to the terminal 508.

The time information in the synchronization request indicates the time when the stored category attribute information corresponding to the category identification in the terminal 508 is generated.

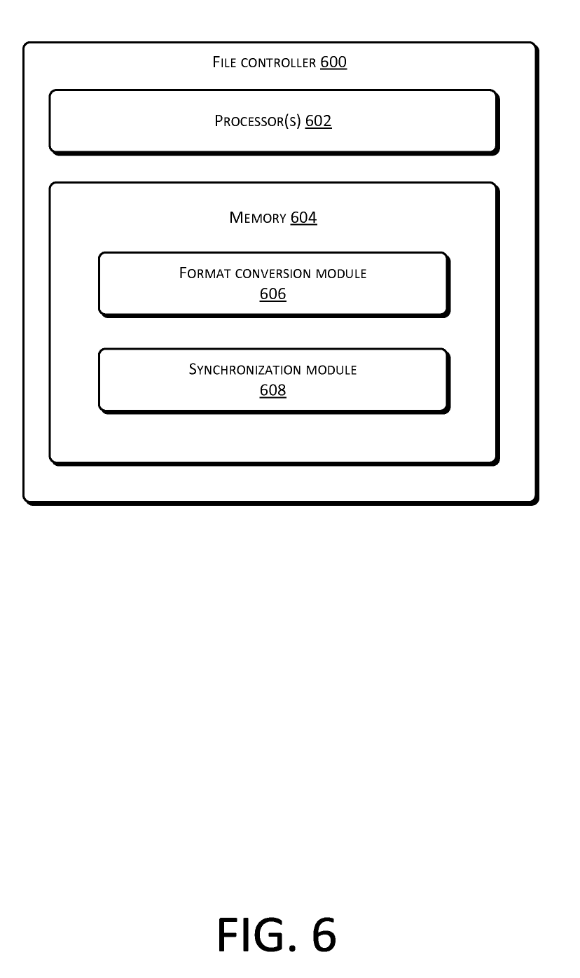

A fourth example embodiment is described in detail below. FIG. 6 illustrates a diagram of an example file controller 600 in accordance with the fourth example embodiment of the present disclosure.

The file controller 600 may include, but is not limited to, one or more processors 602 and memory 604. The memory 604 may include computer storage media in the form of volatile memory, such as random-access memory (RAM) and/or non-volatile memory, such as read only memory (ROM) or flash RAM. The memory 604 is an example of computer storage media.

Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include transitory media such as modulated data signals and carrier waves.

The memory 604 may store therein program units or modules and program data. In one embodiment, the modules may include a format conversion module 606 and a synchronization module 608. These modules may therefore be implemented in software that can be executed by the one or more processors 602. In other implementations, the units may be implemented in firmware, hardware, software, or a combination thereof. The format conversion module 606 converts the category identifications and category attribute information stored in the central data storage media in the form of one or more files. The synchronization module 608 synchronizes the category identifications and category attribute information in the form of files with a category server, instructs the category server to determine a category of a product corresponding to a product identification sent by a terminal, and returns a category identification of the determined category and the category attribute information, corresponding to the category identification, in the form of files to the terminal.

In addition, when the category attribute information stored in the central data storage media are updated, the format conversion module 606 converts the updated category attribute information stored in the central data storage media into the form of one or more files. The synchronization module 608 also synchronizes the updated category attribute information in the form of files with the category server, triggers the terminal to send a synchronization request, instructs the category server to determine whether to send the updated category attribute information in the form of files to the terminal after the category server receives the synchronization request.

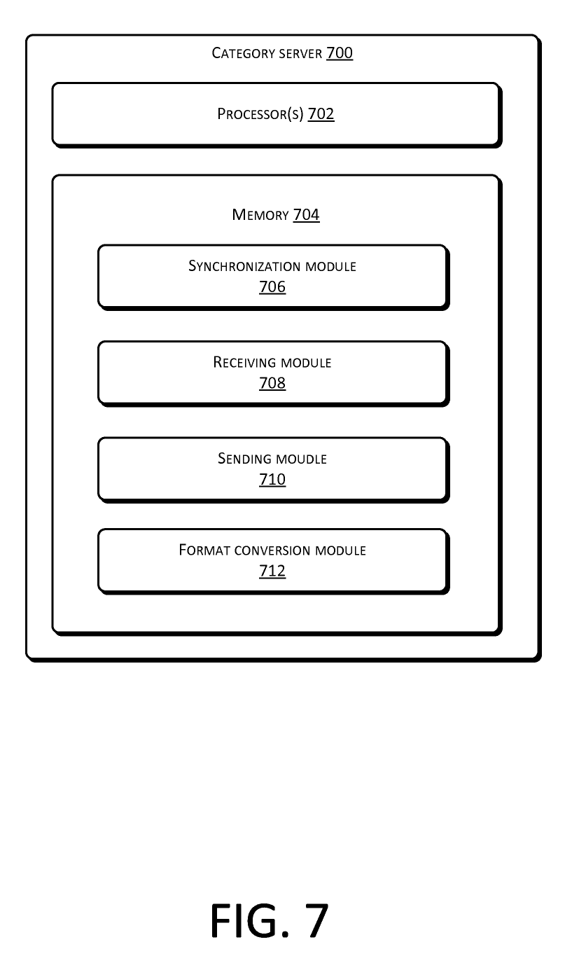

A fifth example embodiment is described in detail below. FIG. 7 illustrates a diagram of an example category server 700 in accordance with the fifth example embodiment of the present disclosure. The category server 700 may include, but is not limited to, one or more processors 702 and memory 704. The memory 704 may include computer storage media in the form of volatile memory, such as random-access memory (RAM) and/or non-volatile memory, such as read only memory (ROM) or flash RAM. The memory 704 is an example of computer storage media.

The memory 704 may store therein program units or modules and program data. In one embodiment, the modules may include a synchronization module 706, a receiving module 708, a sending module 710, and a format conversion module 712. These modules may therefore be implemented in software that can be executed by the one or more processors 702. In other implementations, the units may be implemented in firmware, hardware, software, or a combination thereof.

The synchronization module 706 synchronizes the category identifications and category attribute information stored in the form of one or more files. The receiving module 708 receives a product identification sent by a terminal. The sending module 710 determine a category of a product corresponding to the product identification sent by the terminal, and returns a category identification of the determined category and the category attribute information, corresponding to the category identification, in the form of file to the terminal.

The synchronization module 706 may receive the category information in the form of files from the file controller 600 in the third example embodiment. Alternatively, the synchronization module 706 may also receive the category information converted by the format conversion module 712.

The format conversion module 712 converts category identifications and category attribute information stored in the central data storage media into the form of one or more files, and sends them to the synchronization module 706.

In addition, when the category attribute information stored in the central data storage media is updated, the format conversion module 712 also converts the updated category attribute information stored in the central data storage media into the form of one or more files and triggers the terminal to send a synchronization request. The synchronization module 706 also synchronizes the updated category attribute information in the form of files. The receiving module 708 receives the synchronization request from the terminal. The sending module 710 determines whether to send the updated category attribute information in the form of file to the terminal.

The sending module 710 may use, but not limited to, either of following two example methods to determine whether to send the updated category attribute information in the form of file to the terminal.

In a first example method, when the synchronization request includes the category identification and time information, the sending module 710 compares the received time information and the locally stored time when the category attribute information corresponding to the category identification in the synchronization request is generated. If the category server determines that the time information sent by the terminal is earlier than the locally stored time when the category attribute information corresponding to the category identification is generated, the sending module 710 sends the updated category attribute information, corresponding to the category identification in the synchronization request, in the form of file to the terminal. Otherwise, the sending module 710 does not send the updated category attribute information to the terminal. The time information in the synchronization request indicates the time when the stored category attribute information corresponding to the category identification in the terminal is generated.

In a second example method, the sending module 710, after receiving the synchronization request sent from the terminal, determines the category identifications that have been sent to the terminal and determines whether the category attribute information corresponding to the determined category identifications have been updated. If the category attribute information corresponding to the determined category identifications have been updated, the sending module 710 sends the updated category attribute information, corresponding to the determined category identification, in the form of one or more files to the terminal. Otherwise, the sending module 710 does not send the updated category attribute information to the terminal 508. For example, the synchronization request from the terminal may include an identification of the terminal.

It should be noted that the file controller 600 and the category server 700 in the fourth example embodiment and the fifth example embodiment may also contain other modules that can implement the first example embodiment and the second example embodiment.

Persons skilled in the art should understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.).

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

These computer program instructions can also be stored in other computer-readable storage which can instruct a computer or other programmable data processors to operate in a certain way, so that the instructions stored in the computer-readable storage generate a product containing the instruction device, wherein the instruction device implements the functions specified in one or more flows of the flow chart and/or one or more blocks of the block diagram.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

The embodiments are merely for illustrating the present disclosure and are not intended to limit the scope of the present disclosure. It should be understood for persons in the technical field that certain modifications and improvements can be made and should be considered under the protection of the present disclosure without departing from the principles of the present disclosure.

What is claimed is:

1. A method performed by one or more processors configured with computer-executable instructions, the method comprising:
converting one or more category identifications and one or more category attribute information stored in one or more central data storage media into a form of one or more files;
synchronizing the one or more category identifications and category attribute information in the form of one or more files with a category server;
receiving a product identification of a product sent by a terminal;
instructing the category server to determine one or more categories of the product corresponding to the product identification; and
returning, to the terminal, category identifications and category attribute information of the determined one or more categories in the form of one or more files.

2. A method as recited in claim 1, wherein the product identification of the product corresponds to the one or more categories and each category identification corresponds to respective category attribute information.

3. The method as recited in claim 1, wherein the converting comprises generating a category identification file according to the one or more category identifications stored in the central data storage media, the category identification file including the one or more category identifications.

4. The method as recited in claim 1, wherein the converting comprises generating one or more category attribute information files according to the one or more category attribute information stored in the central data storage media, a respective category attribute information file including category attribute information corresponding to a respective category identification of the one or more category identifications.

5. The method as recited in claim 4, further comprising:
determining that at least one of the category attribute information stored in the central date memory is updated;
converting the updated category attribute information in the central data storage media into the form of one or more files; and
synchronizing the updated category attribute information in the form of one or more files with the category server;
receiving from the terminal a synchronization request; and
instructing the category server to determine whether to send category attribute information in the form of one or more files to the terminal after receiving the synchronization request.

6. The method as recited in claim 5, wherein the receiving comprises:
installing a publication plug-in at the terminal;
sending a notification from a publication server to the publication plug-in that at least one of the category attribute information is updated without considering category identifications already stored at the terminal; and
requesting the terminal to send the synchronization request to the category server.

7. The method as recited in claim 5, wherein the synchronizing the updated category attribute information in the form of one or more files with the category server comprises:
determining whether a respective updated category attribute information file at the central data storage media is stored at the category server;
if the respective updated category attribute information file at the central data storage media is not stored at the category server, synchronizing the respective category attribute information file from the central storage media to the category server.

8. The method as recited in claim 5, wherein the synchronization request includes time information and a category identification that the terminal requests to synchronize with the category server, the time information indicating a time when category attribute information, corresponding to the category identification, stored in the terminal is generated and wherein the instructing comprises:
comparing the time information in the synchronization request and a locally stored time at the category server when category attribute information corresponding to the category identification in the synchronization request is generated,
if the time information in the synchronization request is earlier than the locally stored time at the category server, determining that category attribute information stored at the terminal is out-of-date and sending updated category attribute information at the category server in the form of one or more files to the terminal; and
if the time information in the synchronization request is not earlier than the locally stored time at the category server, determining that category attribute information stored at the terminal is not out-of-date without sending the category attribute information in the form of one or more files to the terminal.

9. The method as recited in claim 5, wherein the synchronization request includes an identification of the terminal and wherein the instructing comprises:
determining one or more category identifications that have been sent to the terminal; and
determining whether the category attribute information corresponding to the one or more category identifications have been updated at the category server;
if the category attribute information corresponding to the one or more category identifications have been updated, determining that category attribute information stored at the terminal is out-of-date and sending the updated category attribute information in the form of one or more files to the terminal; and
if the category attribute information corresponding to the one or more category identifications have not been updated, determining that category attribute information stored at the terminal is not out-of-date without sending the category attribute information in the form of one or more files to the terminal.

10. The method as recited in claim 9, wherein the sending the updated category attribute information in the form of one or more files to the terminal comprises authorizing the terminal to download the category attribute information in the form of one or more files from the category server through a breakpoint continuous transmission.

11. A category server comprising:
one or more processors; and
computer storage media having stored thereon computer-executable instructions that are executable by the one or more processors to perform actions comprising:
synchronizing one or more category identifications and category attribute information in a form of one or more files;
determining one or more categories of a product corresponding to a product identification sent by a terminal; and
returning, to the terminal, category identifications and category attribute information of the determined one or more categories in the form of one or more files.

12. The category server as recited in claim 11, wherein the product identification of the product corresponds to the one or more categories and each category identification corresponds to respective category attribute information.

13. The category server as recited in claim 11, wherein the synchronizing comprises generating a category identification file according to the one or more category identification stored in one or more central data storage media, the category identification file including the one or more category identifications.

14. The category server as recited in claim 13, wherein the synchronizing comprises generating one or more category attribute information files according to the one or more category attribute information stored in the central data storage media, a respective category attribute information file including category attribute information corresponding to a respective category identification of the one or more category identifications.

15. The category server as recited in claim 14, further comprising:
determining that at least one of the category attribute information stored in the central date memory is updated;
converting the updated category attribute information in the one or more central data storage media into the form of one or more files; and
synchronizing the updated category attribute information in the form of one or more files from the one or more central data storage media to the category server;
receiving from the terminal a synchronization request;
determining whether to send category attribute information in the form of one or more files to the terminal after receiving the synchronization request.

16. The category server as recited in claim 15, wherein the receiving comprises:
sending a notification to the terminal that at least one category attribute information is updated without considering category identifications already stored at the terminal; and
requesting the terminal to send the synchronization request to the category server.

17. The category server as recited in claim 15, wherein the synchronizing the updated category attribute information in the form of one or more files with the category server comprises:
determining whether a respective updated category attribute information file at the central data storage media is stored at the category server;
if the respective updated category attribute information file at the central data storage media is not stored at the category server, synchronizing the respective category attribute information file from the central storage media to the category server.

18. The category server as recited in claim 15, wherein the synchronization request includes time information and a category identification that the terminal requests to synchronize with the category server, the time information indicating a time when category attribute information, corresponding to the category identification, stored in the terminal is generated and wherein the instructing comprises:
comparing the time information in the synchronization request and a locally stored time at the category server when category attribute information corresponding to the category identification in the synchronization request is generated,
if the time information in the synchronization request is earlier than the locally stored time at the category server, determining that category attribute information stored at the terminal is out-of-date and sending updated category attribute information at the category server in the form of one or more files to the terminal; and
if the time information in the synchronization request is not earlier than the locally stored time at the category server, determining that category attribute information stored at the terminal is not out-of-date without sending the category attribute information in the form of one or more files to the terminal.

19. The category server as recited in claim 15, wherein the synchronization request includes an identification of the terminal and wherein the instructing comprises:
determining one or more category identifications that have been sent to the terminal; and
determining whether the category attribute information corresponding to the one or more category identifications have been updated at the category server;
if the category attribute information corresponding to the one or more category identifications have been updated, determining that category attribute information stored at the terminal is out-of-date and sending the updated category attribute information in the form of one or more files to the terminal; and
if the category attribute information corresponding to the one or more category identifications have not been updated, determining that category attribute information stored at the terminal is not out-of-date without sending the category attribute information in the form of one or more files to the terminal.

20. One or more computer storage media having stored thereon computer-executable instructions that are executable by the one or more processors to perform actions comprising:
determining that at least one of the category attribute information stored in the central date memory is updated;
converting the updated category attribute information in the central data storage media into a form of one or more files; and
synchronizing the updated category attribute information in the form of one or more files with the category server;
receiving from the terminal a synchronization request without considering category identifications already stored at the terminal, the synchronization request includes time information and a category identification that the terminal requests to synchronize with the category server, the time information indicating a time when category attribute information, corresponding to the category identification, stored in the terminal is generated; and
determining whether to send category attribute information in the form of one or more files to the terminal after receiving the synchronization request, the determining including:
comparing the time information in the synchronization request and a locally stored time at the category server when category attribute information corresponding to the category identification in the synchronization request is generated,
if the time information in the synchronization request is earlier than the locally stored time at the category server, determining that category attribute information stored at the terminal is out-of-date and sending updated category attribute information at the category server in the form of one or more files to the terminal, the sending including authorizing the terminal to download the category attribute information in the form of one or more files from the category server through a breakpoint continuous transmission; and
if the time information in the synchronization request is not earlier than the locally stored time at the category server, determining that category attribute information stored at the terminal is not out-of-date without sending the category attribute information in the form of one or more files to the terminal.
